(19) United States
(12) Patent Application Publication
(10) Pub. No.: US 2004/0019510 A1
(43) Pub. Date: Jan. 29, 2004

(54) Production management system, program, information storage medium and method of production control

(75) Inventors: Junichi Takeuchi, Chino-shi (JP); Tomoaki Tsuchida, Suwa-shi (JP); Hideyuki Mitani, Sakata-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/456,973

(22) Filed: Jun. 6, 2003

(30) Foreign Application Priority Data
Jun. 10, 2002 (JP) 2002-168916
Mar. 5, 2003 (JP) 2003-058921

(51) Int. Cl. G06F 17/60

(52) U.S. Cl. 705/7

(57) ABSTRACT

A production management system includes an input device that inputs a request from a user. The system also includes a processor that computes a total cost in response to the request inputted by the input device based on a cost database in standby time relating used equipment to a cost per unit time in standby time, which shows a cost in standby time for every predetermined time unit varying in response to an elapsed time, a cost database in disposal time relating used equipment to a cost per unit disposal volume, which shows a cost in processing time every predetermined disposal unit varying in response to a production condition and a disposal volume, and a database for production process information relating used equipment to a production condition and a production process. The system further includes an output device that indicates the total cost computed by the processor to the user by a predetermined format. The request includes a designation for production conditions showing a designation of the production conditions and a designation for aggregation unit showing the designation of aggregation unit in response to a size of the production process. The processor selects at least one of used equipment in response to the designation for production condition. The processor also computes a total cost in standby time in response to the designation of aggregation unit, based on an assumed standby time of the used equipment, and a cost in standby time per unit time of the used equipment. The processor further computes a total cost in disposal time in response to the designation of aggregation unit, based on a designation of disposal volume included in the designation of the production condition, and a cost in disposal time per unit disposal volume of the used equipment selected in response to the designation for the production condition, and computes the total cost based on the total cost in standby time and the total cost in disposal time.

### BACKGROUND OF THE INVENTION

1. Field of the Invention

The present invention relates to a production management system, a program, an information storage medium and a production control method.

2. Description of the Related Art

Conventionally, production cost and production energy are derived from a method based on the experience of an engineer and a manager referring to production cost of material and known quantities of energy for every unit such as a production.

However, in such a method, calculated results are different depending on the engineers and the managers and it takes a lot of time and labor to calculate the results. In particular, in the case of having many production processes such as manufacturing a semiconductor device, it is difficult to calculate an accurate production cost and production energy.

In addition, in manufacturing a semiconductor device, production conditions are modified and orders for production processes are changed. In such cases, it takes much time and enormous labor power to recalculate the production cost and production energy.

For example, there are known support equipment for examining a cost, which outputs manufacturing and mounting costs for every production line by inputting production planning information or component information, and using a database and an algorithm.

However, the known support equipment for examining a cost disclosed is only a structure once performed by human beings now replaced with a computer, not a structure, which can compute a cost more flexibly in case of modifying process conditions and other conditions.

Viewed from such problem, the present invention is intended to provide a production management system, a program, an information storage medium and a production control method, which can compute costs effectively and accurately for every predetermined process unit in production lines and plants.

### SUMMARY OF THE INVENTION

A production management system includes an input device that inputs a request from a user. The system also includes a processor that computes a total cost in response to the request inputted by the input device based on a cost database in standby time relating used equipment to a cost per unit time in standby time, which shows a cost in standby time for every predetermined time unit varying in response to an elapsed time, a cost database in disposal time relating used equipment to a cost per unit disposal volume, which shows a cost in processing time every predetermined disposal unit varying in response to a production condition and a disposal volume, and a database for production process information relating used equipment to a production condition and a production process. The system further includes an output device that indicates the total cost computed by the processor to the user by a predetermined format. The request includes designation for production conditions showing a designation of the production conditions and a designation for aggregation unit showing the designation of aggregation unit in response to a size of the production process. The processor selects at least one of used equipment in response to the designation for production condition. The processor also computes a total cost in standby time in response to the designation of aggregation unit, based on an assumed standby time of the used equipment, and a cost in standby time per unit time of the used equipment. The processor further computes a total cost in disposal time in response to the designation of aggregation unit, based on a designation of disposal volume included in the designation of the production condition, and a cost in disposal time per unit disposal volume of the used equipment selected in response to the designation for the production condition, and computes the total cost based on the total cost in standby time and the total cost in disposal time.

### BRIEF DESCRIPTION OF THE DRAWINGS

FIG. 1 is a schematic block diagram showing a recipe cost related to one example of the present embodiment and concept of an idle cost.

FIG. 2 is a functional block diagram of production management system relating to one example of the present embodiment.

FIG. 3 is a flow chart showing a flow of production control process relating to one example of the present embodiment.

FIG. 4 is a schematic block diagram of an image for data input regarding production equipment related to one example of the present embodiment.

FIG. 5 is a schematic block diagram of an image for data input regarding to miscellaneous equipment related to one example of the present embodiment.

FIG. 6 is a schematic block diagram of an image for data input regarding to production disposal related to one example of the present embodiment.

FIG. 7 is a schematic block diagram showing the concept of RPT and PIT related to one example of the present embodiment.

FIG. 8 is a schematic block diagram of an image for data input regard to production process related to one example of the present embodiment.

FIG. 9 is a schematic block diagram of an image showing the total cost aggregation related to one example of the present embodiment.

FIG. 10 is a schematic block diagram of an image showing the result of computing time for equipment related to one example of the present embodiment.

FIG. 11 is a schematic block diagram of an image showing the result of equipment cost aggregation related to one example of the present embodiment.

FIG. 12 is a schematic block diagram of an image showing the result of cost aggregation every process related to one example of the present embodiment.

FIG. 13 is a schematic block diagram of an image showing the result of cost aggregation for every piece of equipment related to one example of the present embodiment.

FIG. 14 is a schematic block diagram of an image showing the result of cost aggregation for every piece of equipment related to one example of the present embodiment.

### DETAILED DESCRIPTION OF THE PREFERRED EMBODIMENTS

The present invention will be explained referring to the drawings hereafter, where the present invention is applied to a production management system that manages equipment for manufacturing a semiconductor device. Here, embodiments described hereafter, do not limit the spirit of the invention described in the scope of the claims. In addition, all of constituents disclosed in the following embodiments may not be necessarily required as means for solving problems.

(Description of a Whole System)

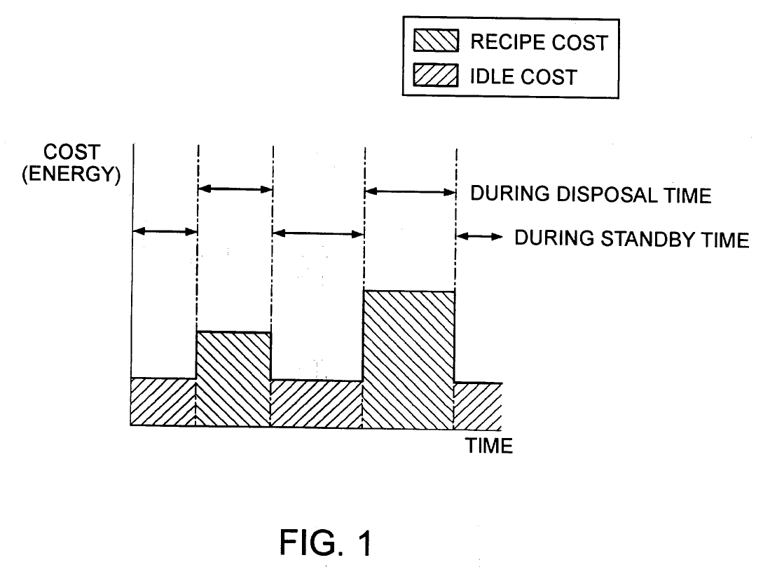

FIG. 1 shows a schematic view of the present embodiment relating to the concept of a recipe cost and an idle cost.

Here, the idle cost is a cost in standby time varying in response to elapsed time in a standby time. In other words, the idle cost is a cost, which does not produce additional value because of no variation in process volumes. In addition, in the present embodiment, the idle cost for every predetermined time unit (for example, one minute, one hour) is referred to as an idle cost per unit time (a cost per unit time in standby time).

In addition, the recipe cost is a cost during process time, which varies in response to production conditions (for example, used chemicals, production process orders and so on) and process volumes (for example, a piece of semiconductor wafer and so on). In other words, the recipe cost is a cost, which produces additional value because of a variation in process volumes. In addition, in the present embodiment, the recipe cost for every predetermined disposal unit (for example, one piece of wafer) is referred to as a recipe cost per unit disposal volume (a cost per unit disposal in disposal time).

As shown in FIG. 1, when equipment for manufacturing a semiconductor device implements manufacturing processes, the recipe cost is generated. On the other hand, when equipment for manufacturing a semiconductor device does not implement manufacturing processes, only the idle cost is generated.

In addition, a cost varying depending on process volumes is generally called a running cost. However, the recipe cost in the present embodiment is different from a simple running cost in view of its varying in response to production conditions and process volumes.

The production management system in the present embodiment implements aggregation in response to user requirements and indicates a total cost to a user. Here, this request includes a designation for a process condition indicating process conditions (for example, names of used materials, process volumes and so on) and a designation for an aggregation unit indicating an aggregation unit (for example, a plant unit, an equipment unit and so on).

At first, the production management system selects at least one piece of equipment in use in response to a designation for a process condition from a user and computes a total idle cost (a total cost in standby time) in response to a designation for an aggregation unit, based on assumed standby time and the idle cost per unit time for the piece of equipment in use.

In addition, the production management system computes a total recipe cost (a total cost in disposal time) in response to a designation for an aggregation unit, based on process volumes included in production conditions and a recipe cost per unit disposal volume for the equipment in use selected in response to a designation for production conditions.

Hence, the production management system computes a total cost obtained by adding the total idle cost to the total recipe cost so as to indicate the total cost in response to the user's designation.

Furthermore, according to the present embodiment, a database having a structure corresponding to the idle cost per unit time and the recipe cost per unit process volume is adopted as a database for various operations.

Hence, the production management system can indicate the aggregation result effectively and precisely in response to various requests from a user.

Next, a functional block diagram of the production management system is described in order to realize the above-mentioned function.

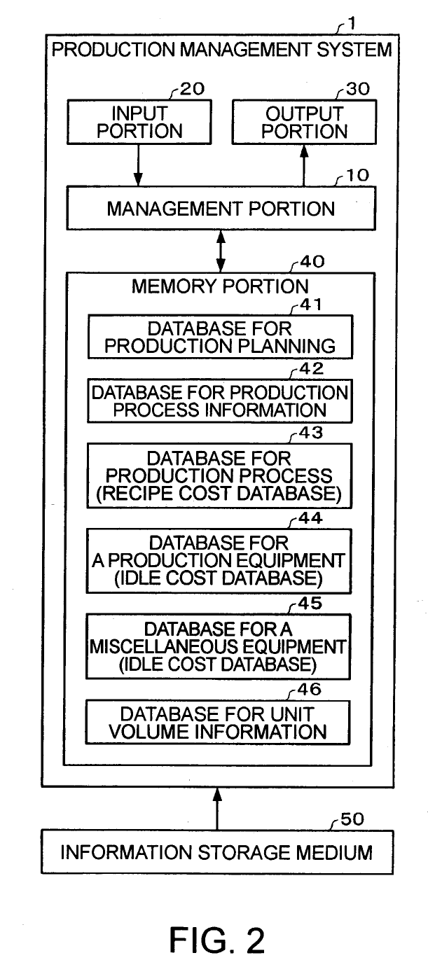

FIG. 2 shows a functional block diagram of a production management system 1 related to one of the embodiments of the present invention.

The production management system 1 includes an input portion 20 inputting a request from a user, a memory portion 40 storing various databases, a management portion 10 computing the total cost in response to the request input by the input portion 20 and an output portion 30 indicating the total cost computed by the management portion 10 to a user by a predetermined format.

In addition, the memory portion 40 stores a database for production planning 41 indicating production conditions designated by a user, a database for production process information 42 relating production conditions and production processes to used equipment, a database for production process 43, which is a recipe cost database (a cost database in disposal time) relating the recipe cost per process volume unit to used equipment, a database for production equipment 44, which is the idle cost database (a cost database in standby time) relating the idle cost per unit time to used equipment, a database for miscellaneous equipment 45 and a database for unit volume information 46.

Here, the database for production planning 41 includes, for example, product codes, the number of produced wafers and others. In addition, the database for production process information 42, for example, includes product codes, production process names, production condition codes, and production equipment codes. In addition, the database for production process 43, includes production condition codes, production equipment codes, disposition time per one piece of wafer, used material names, used power names, the volume of used material, the volume of used power, and a maintenance cost depending disposal.

In addition, according to the present embodiment, since the production management system 1 is applied to a management for manufacturing equipment for a semiconductor device, used equipment includes equipment directly related to manufacturing a semiconductor device (for example, an apparatus for cleaning a wafer) and supplemental equipment used for supporting manufacturing equipment instead of directly manufacturing a semiconductor device (for example, equipment for removing harm). Hence, the database for manufacturing equipment 44 is installed as the database showing information with regard to production equipment and the database for miscellaneous equipment 45 is installed as the database showing information with regard to miscellaneous equipment.

In detail, the database for manufacturing equipment 44 includes production equipment codes, a volume of used electric power per one minute, and a maintenance cost per one minute. In addition, the database for miscellaneous equipment 45 includes production equipment codes, a volume of used electric power per one minute, a depreciation cost per one minute, a maintenance cost per one minute, and the number of connected production equipment.

In addition, the database for unit volume information 46 includes unit price information for materials, unit price information for power usage, unit price information for energy, and energy coefficient.

Here, the production management system 1 may be mounted for example, in a PC (Personal Computer), or each portion of the production management system 1 may be distributed into plural PCs. For example, when mounting in a PC, the management portion 10 can be realized by a CPU, the input portion 20 by a keyboard, a bar code reader, a voice-input device, and a touch panel, the output portion 30 by a video card, a liquid crystal display, a printer, and a projector and the memory portion 40 by RAM.

Further, a program may be read out from the information storage medium 50, which stores a program for making a computer function as the management portion 10 and others so as to make a computer realize the function of the management portion 10 and others.

As such, information storage medium 50, for example, a CD-ROM, a DVD-ROM, a ROM, a RAM and a HDD can be applied, even if a method of reading a program may be contact type or may be non-contact type.

In addition, instead of the information storage medium 50, it is possible to realize the above-mentioned functions of the management portion 10 by downloading a program, which realizes the above-mentioned functions via the transmission path.

(Description of the Processing Flow)

Next, the processing flow using the management portion 10 and others is described.

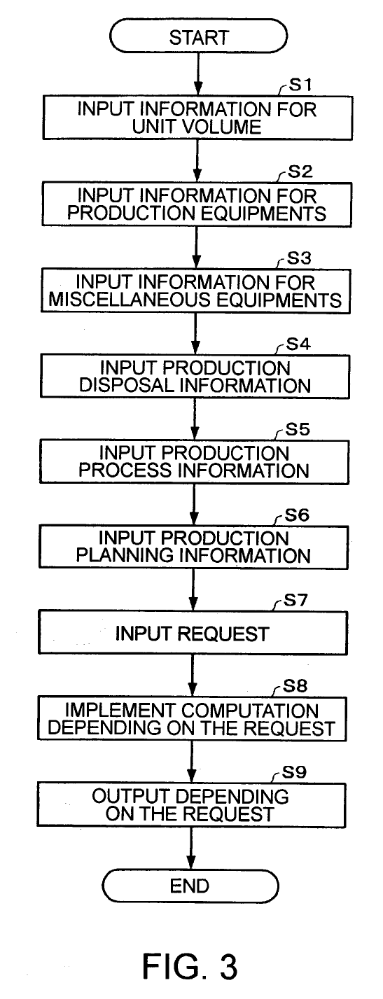

FIG.3 shows a flow chart indicating a flow of the production management process. Here, a flow of the production management process where a designer in a plant newly designs a plant by using a plurality of production equipment and miscellaneous equipment, is described along with the order of a method of constructing a database architecture and a database usage.

(Description of a Method of Constructing a Database)

A plant designer installs the database for production disposal 43, the database for production equipment 44, the database for miscellaneous equipment 45 and the database for unit volume information 46 in a memory portion 40 in advance before using the database.

Hence, the plant designer inputs unit volume information from an input portion 20 (step S1). Here, unit volume information can be, for example, unit prices for materials, unit prices for power usage and unit prices for energy.

The management portion 10 updates the database for the unit volume information 46 based on the unit volume information. The management portion 10, for example, can compute a total cost of used materials, based on the total volume of used materials and unit prices for these materials in the database for the unit volume information 46 by referring to the database for the unit volume information 46.

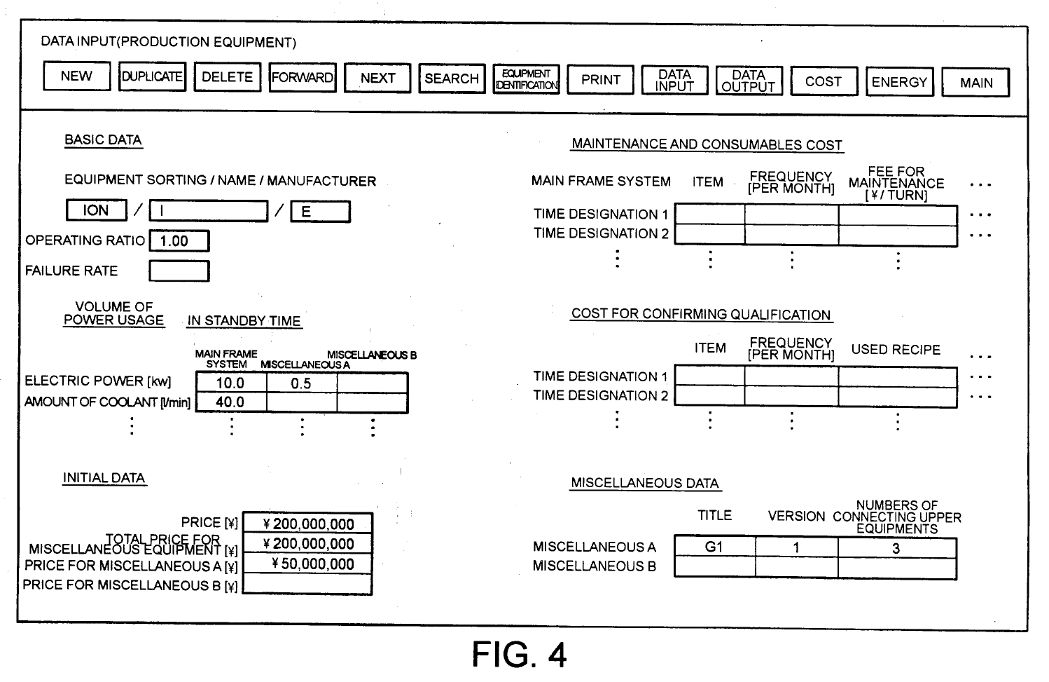

In addition, the plant designer inputs the information for production equipment from the input portion 20 (step S2). FIG. 4 shows a schematic block diagram of an image for data input regarding production equipment related to one example of the present embodiment. Here, production equipment means equipment producing produced objects (semiconductor wafers in the present embodiment) directly. In detail, for example, these include a wafer cleaning apparatus, etching equipment and others.

As shown in FIG. 4, various kinds of input items are included in the image for data input regarding production equipment. These include, for example, equipment sorting, equipment identification, a numbered machine, a version of production equipment, equipment sorting, device name, a manufacturer of equipment, operating ratio, a miscellaneous equipment identifier, a version of a miscellaneous equipment, the price of main frame production equipment [¥], the price of miscellaneous equipment [¥], used electric power during idle time [kw], an amount of coolant water during idle time [1/min], a maintenance item designated by time, total working hours for maintenance, frequency for maintenance, a fee for maintenance, recipe name for qualification designated by time, confirmed number of pieces for qualification (pieces), time for confirming qualification (h), fee for confirming qualification [¥/turn], energy for confirming qualification [kwh/turn], a qualification item for a specified item by designating time, and frequency for confirming qualification [turn/day].

The management portion 10 updates the database for production equipment 44 and the database for production disposal 43 based on production equipment information.

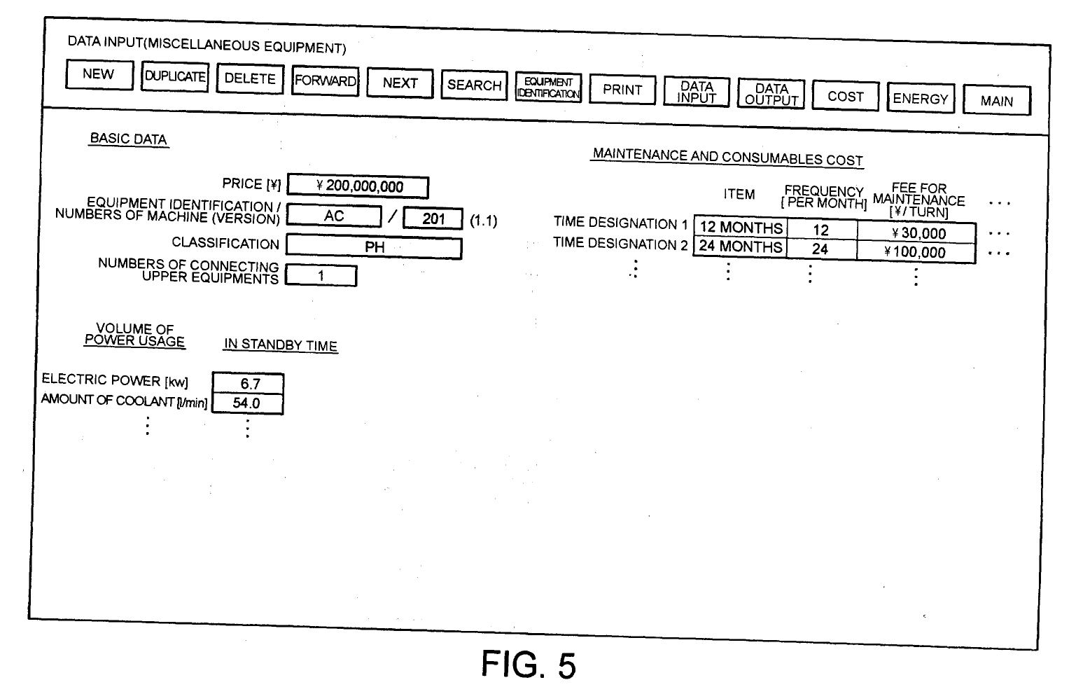

Furthermore, a plant designer inputs the information for miscellaneous equipment from the input potion 20 (step S3). FIG. 5 shows a schematic block diagram of an image for data input regarding miscellaneous equipment related to one example of the present embodiment. In addition, miscellaneous equipment means equipment assisting production equipment instead of producing objects to be produced directly. In detail, for example, these are equipment for removing harm that removes harm in wastes from production equipment.

As shown in FIG. 5, various kinds of input items are included in an image for data input regarding miscellaneous equipment. These include, for example, names of miscellaneous equipment, numbered machines, versions, sorting miscellaneous equipment, number of equipment for upper connection, prices of miscellaneous equipment [¥], used electric power during idle time [kw], amount of coolant water during idle time [1/min], maintenance items designated by time, total working hours for maintenance, frequency for maintenance, a fee for maintenance, recipe names for qualification designated by time, confirmed number of pieces for qualification (pieces), time for confirming qualification (h), a fee for confirming qualification [¥/turn], energy for confirming qualification [kwh/turn], qualification items for specified items by designating time, and frequency for confirming qualification [turn/day]. In addition, “a piece” means one piece of wafer, and it is described as “wf” in the figure.

In addition, the management portion 10 updates the database for miscellaneous equipment 45 based on miscellaneous equipment information.

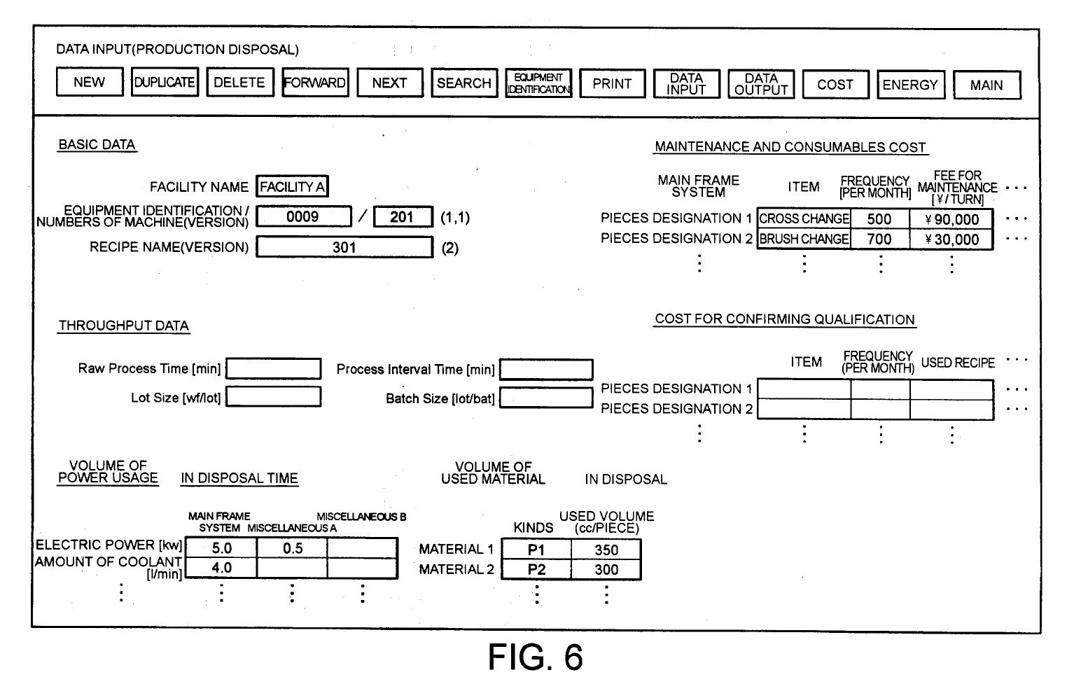

In addition, a plant designer inputs production disposal information from the input portion 20 (step S4). FIG. 6 shows a schematic block diagram of an image for data input regarding production disposal related to one example of the present embodiment.

As shown in FIG. 6, these items of production disposal include, for example, names of production facilities, equipment identification, numbered machines, versions, names of recipes, RPT (Raw Process Time)[minute] lot size (pieces/lot), batch size (lots/batch), used electric power for production equipment [kw/min], an amount of coolant water for production equipment [1/min], an amount of used electric power for miscellaneous equipment [kw/min], an amount of coolant water for miscellaneous equipment [1/min], material names, amount of used materials (cc/piece), maintenance items designated by piece, total working hours for maintenance [h], frequency for maintenance [times/month], a fee for maintenance [yen/time], recipe names for qualification designated by piece, confirmed number of pieces for qualification (pieces), time for confirming qualification (h), a fee for confirming qualification [yen/time], energy for confirming qualification [kwh/time], qualification items for specified items by designating piece, frequency for confirming qualification [times/piece], and names of used recipe and used wafers (pieces).

Here, RPT and PIT are described below.

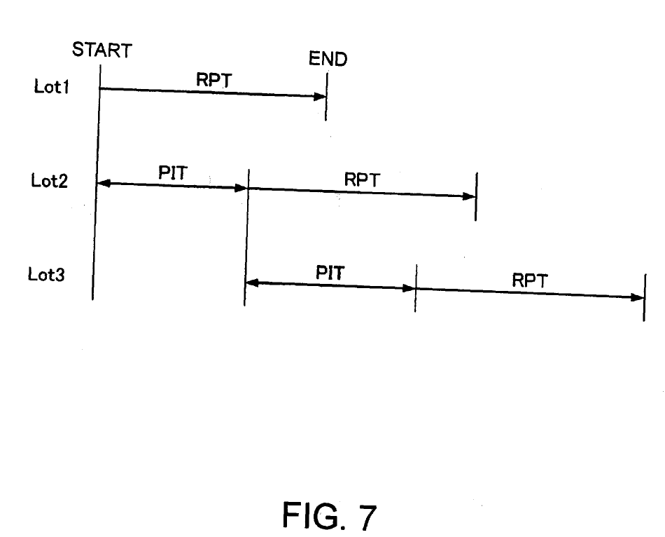

FIG. 7 is a schematic block diagram showing the concept of RPT and PIT related to one example of the present embodiment.

RPT means time from starting disposal per one piece of wafer to ending the disposal. In addition, PIT means a time interval from applying a wafer to applying the next wafer.

The management portion 10 stores RPT, PIT, a lot size showing the number of wafers per lot, and a batch size showing the number of lots per unit disposal, as recipe information in the information for production disposal 43 such that it is possible to calculate a cost precisely not only in case of a plurality of disposals linearly, but a plurality of disposals in parallel. Further, it is possible to recalculate it even if production conditions such as RPT and others are changed.

The management portion 10 updates the information for production disposal 43 based on production process information input by a user.

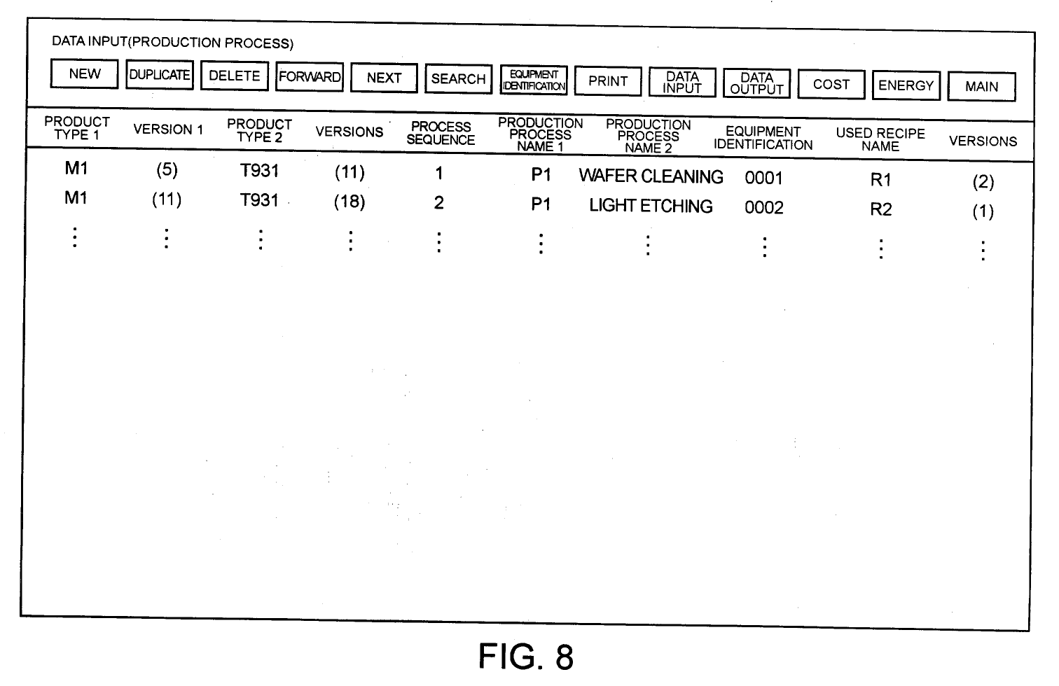

Then, a plant designer inputs production process information from the input potion 20 (step S5). FIG. 8 shows a schematic block diagram of an image for data input regarding production process related to one example of the present embodiment.

The management portion 10 updates the database for production process 42 based on production process information.

Then, a plant designer inputs production planning information from the input portion 20 (step S6).

As items of production planning information, there are, for example, product type names 1, version of product type names 1, product type names 2, versions of product type names 2, process sequence, production process names 1, production process names 2, equipment identification, used recipe names, and versions of used recipe names.

The production management portion 10 updates the database for production planning 41 based on production planning information.

Based on the above-mentioned disposals, a plant designer can construct the database for production disposal 43, the database for production equipment 44, the database for miscellaneous equipment 45, and the database for unit volume information 46 in the memory portion 40.

Here, in detail, methods of.constructing the recipe cost database and the idle cost database are described.

As described above, the recipe cost database, namely a cost of the database for production disposal 43 has a data structure corresponding to the recipe cost for unit disposal volume.

In detail, a recipe cost of unit disposal volume [yen/piece]=a cost for power usage per piece+a material cost per piece+a maintenance cost depending on process volume per piece+a quality confirmation cost depending on process volume per piece.

Here, a cost for power usage per piece=a volume of power usage×unit price for power usage×disposal time. This volume of power usage and the disposal time are input by the input of production disposal information shown in FIG. 6 (step S4). In addition, unit price for power usage is input by the input of unit volume information (step S1). Therefore, the management portion 10 can compute a cost for power usage per piece based on this information.

In addition, a material cost per piece=a volume of used material×unit price of material. This volume of used material is input by the input of production disposal information shown in FIG. 6 (step S4). In addition, unit price of material is input by the input of unit volume information (step S1). Therefore, the management portion 10 can compute a material cost per one piece based on this information.

In addition, a maintenance cost depending on process volume per piece a maintenance cost depending on process volume/frequency of maintenance [piece] and a quality confirmation cost depending on process volume per piece=quality confirmation cost depending on process volume/frequency of quality confirmation (piece). The maintenance cost depending on disposal volume, the frequency of maintenance, quality confirmation cost depending on disposal volume and frequency of quality confirmation are input by the input of production disposal information shown in FIG. 6 (step S4). Therefore, the management portion 10 can compute the maintenance cost depending on disposal volume per piece and a quality confirmation cost depending on disposal volume per piece based on this information.

Hence, based on the above-mentioned steps, the management portion 10 can compute a recipe cost for unit disposal volume for every piece of equipment and stores it as a part of the database for production disposal 43.

In addition, as described above, the idle cost database, namely the database for production equipment 44 and the cost of the database for miscellaneous equipment 45 have a data structure corresponding to an idle cost per unit time.

In detail, an idle cost per unit time [yen/min]=a cost for power usage per minute in standby time+a depreciation cost in standby time per minute+a maintenance cost depending on time per minute in standby time+a quality confirmation cost depending on time per minute in standby time.

Here, a cost for power usage per minute in standby time=a cost for power usage in standby time/standby time. This cost for power usage in standby time is input by the input of the production equipment information shown in FIG. 6 (step S2). In addition, standby time can be obtained from the computing ratio of the input of the production equipment information. Therefore, the management portion 10 can compute a cost for power usage per minute in standby time based on this information.

In addition, the depreciation cost per minute in standby time=the depreciation cost/standby time. The depreciation cost can be obtained from the process of a main frame of production equipment and others input by the input of production equipment information (step S2). In addition, standby time can be obtained from the computing ratio of the input of production equipment information. Therefore, the management portion 10 can compute the depreciation per minute in standby time based on this information.

In addition, a maintenance cost depending on time per minute in standby time=a maintenance cost depending on time/standby time and a quality confirmation cost depending on time per minute=quality confirmation cost depending on time per minute in standby time/standby time. This maintenance cost depending on time and a quality confirmation cost depending on time are input by the input of the production equipment information shown in FIG. 4 (step S2). Therefore, the management portion 10 can compute the maintenance cost depending on time per minute in standby time and a quality confirmation cost depending on time per minute in standby time.

In addition, the management portion 10 can compute the idle cost per unit time regarding miscellaneous equipment by the same steps.

Based on the above-mentioned steps, the management portion 10 computes the idle cost per unit time for every piece of equipment and stores it as part of the database for production equipment 44 or the database for miscellaneous equipment 45.

Thus, the production management system 1 establishes the database for production disposal 43 having a data structure corresponding to the recipe cost per unit disposal volume, the database for production equipment 44 having a data structure corresponding to the idle cost per unit time, the database for miscellaneous equipment 45 such that it can output data effectively and precisely in response to a user's request.

(Description of a Method of Using a Database)

Next, a method of using the database is described. At first, a plant designer inputs a request from the input unit 20 (step S7).

This request includes a designation of production conditions for designating production conditions and a designation of total unit for designating total unit in response to the size of production process.

The management portion 10 implements computations depending on the request (step S8).

In detail, the management portion 10 selects the production equipment and the miscellaneous equipment, which are suitable for designated production conditions, computes assumed standby time for these used equipment and the idle cost in response to the assumed standby time and computes the total idle cost in response to a designation for aggregate unit based on the idle cost. Here, assumed standby time can be obtained from computing the ratio of used equipment.

In addition, the management portion 10 computes the recipe cost of the production equipment, which is selected depending on a designation for production conditions, and computes the total recipe cost in response to the designation for aggregate unit.

Furthermore, the management portion 10 adds the total recipe cost to the total idle cost, so as to compute the total cost.

In addition, the output portion 30 outputs depending on a request from a designer (step S9).

In the present embodiment, the management portion 10 is constructed so as to enable total cost aggregation, operating time aggregation for equipment, an equipment cost aggregation and cost aggregation for each piece of equipment to be implemented. An image showing these aggregating results is described thereafter.

A user can confirm the aggregated result by designating the total cost aggregation, the operating time aggregation for a piece of equipment, the equipment cost aggregation and the cost aggregation for each piece of equipment via a main image displayed by the output portion 30.

When a user requests the total cost aggregation, the output portion 30 displays an image showing the total cost aggregation.

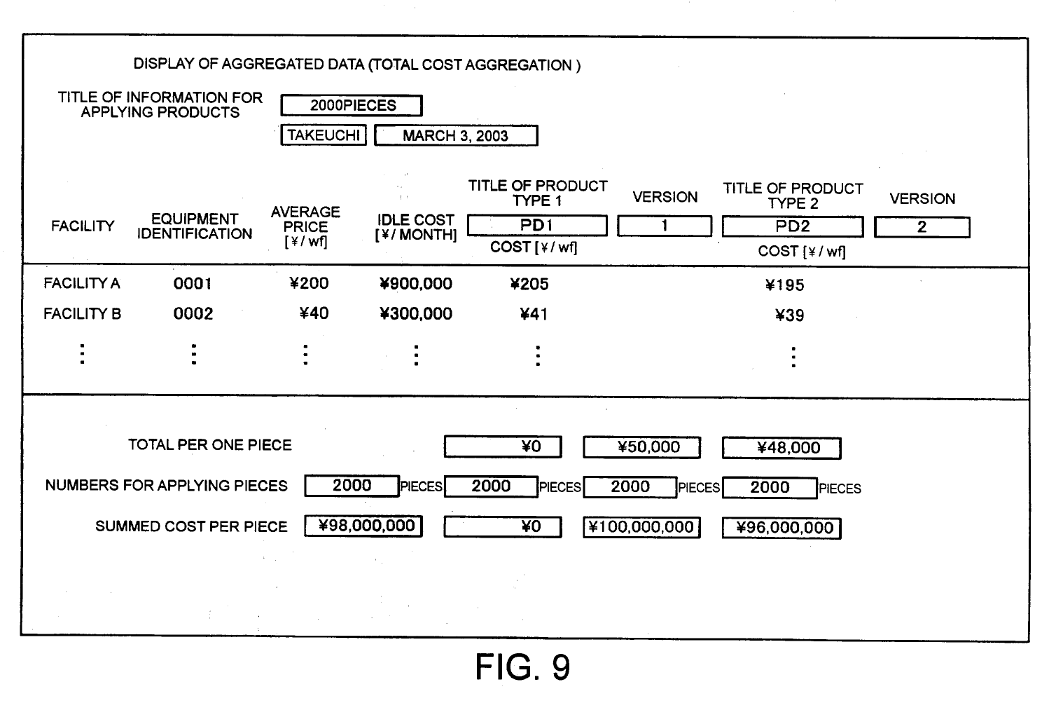

FIG. 9 is a schematic block diagram of an image showing the total cost aggregation regarding one example of the present embodiment.

The image showing the total cost aggregation displays facility names provided with equipment, equipment identification, mean unit price per one piece, an idle cost per month, a recipe cost per one piece of wafer for each piece of equipment and a recipe cost per one piece of wafer for each piece of equipment.

In addition, as shown in FIG. 9, the image showing total cost aggregation displays a recipe cost per one piece of wafer for each piece of equipment and a recipe cost per one piece of wafer for each piece of equipment depending on the product type and version.

Hence, a user can compare a cost for every product type or a cost for every version.

Thus, the database for production process information 42, the database for production disposal 43, the database for production equipment 44 and the database for miscellaneous equipment 45 can be related to the product type and version such that the management portion 10 can effectively implement operations for every product type and every version depending on the user's requirement.

In addition, when a user requests the operation time aggregation for equipment, the output portion 30 displays an image showing the result of the operating time aggregation for equipment.

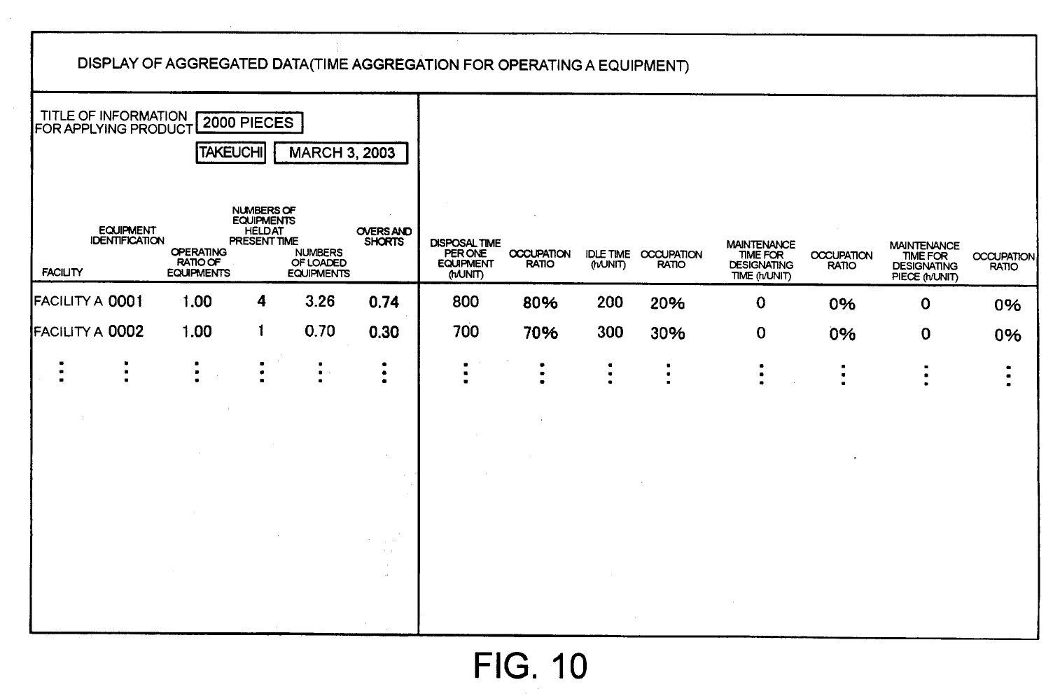

FIG. 10 is a schematic block diagram of an image showing the result of the operating time aggregation for equipment relating to one example of the present embodiment.

The image showing the result of the operation time aggregation for equipment displays facility names provided with equipment, equipment identification, operating ratio of equipment, the number of pieces of equipment held at present, the number of pieces of loaded equipment, overs and shorts, production disposal time per one piece of equipment, occupation ratio for production disposal time, maintenance time for designating time indicating implementing maintenance every how many hours per one piece of equipment, and maintenance time for designating piece indicating implementing maintenance every how many wafers per unit equipment.

Hence, a user can confirm whether a piece of equipment is under operation appropriately, or whether there is overs and shorts of equipment.

In addition, when a user requests the equipment cost aggregation, the output portion 30 displays an image showing the result of the equipment cost aggregation.

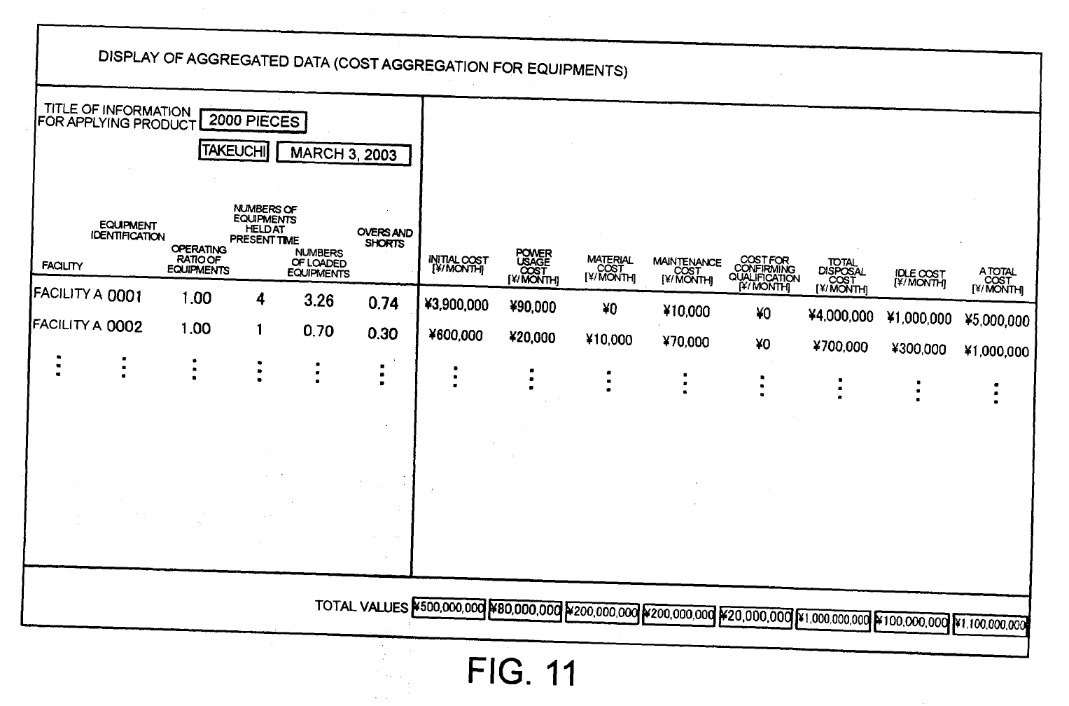

FIG. 11 is a schematic block diagram of an image showing the result of the equipment cost aggregation relating to one example of the present embodiment.

The image showing the result of equipment cost aggregation displays facility names provided with equipment, equipment identification, computing ratio of equipment, the number of pieces of equipment held at present, the number of pieces of loaded equipment, overs and shorts, various monthly costs for each piece of equipment (an initial cost, a power usage cost, a material cost, a maintenance cost, a cost for confirming qualification, a total disposal cost by adding these costs, an idle cost, a total cost by adding the total disposal cost to the idle cost) and aggregated values by aggregating these various costs for all equipment.

Hence, a user can ensure which item of which equipment costs how much expenditure.

In addition, when a user requests the cost aggregation for every production process, the output portion 30 displays an image showing the result of the cost aggregation for every production process.

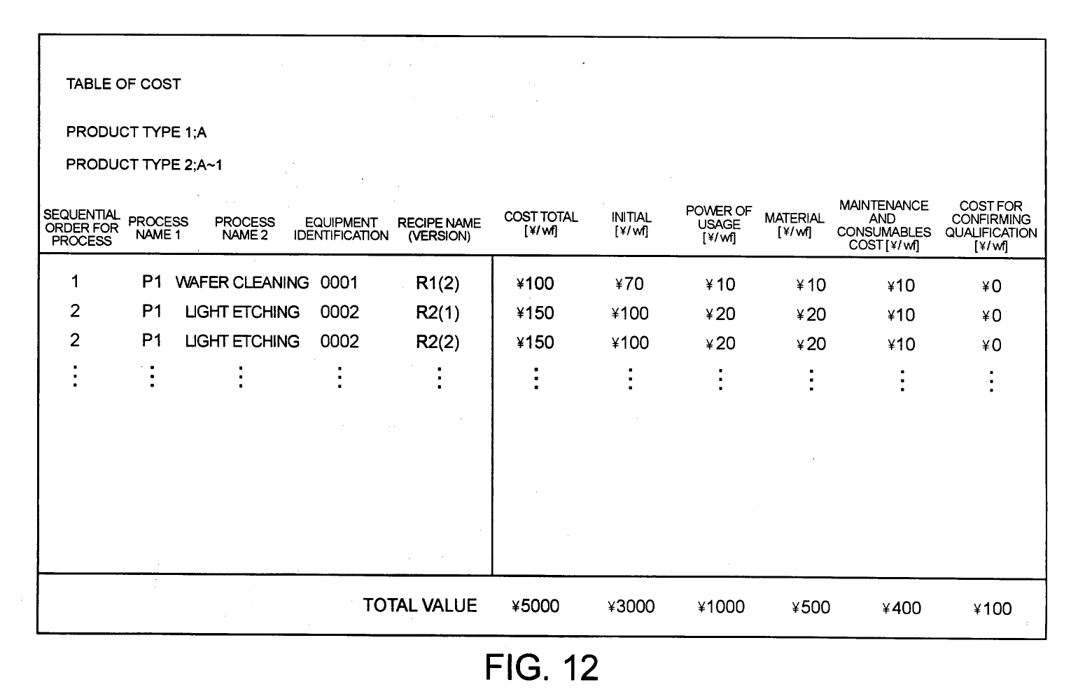

FIG. 12 is a schematic block diagram of an image showing the result of cost aggregation for every process relating to one example of the present embodiment.

The image showing the result of cost aggregation displays the sequential order for process, a process name 1 under a main classification, a process name 2 indicating more detail than the process name 1, a recipe name (production condition name), a version of the recipe, various costs every recipe or version (an initial cost, a power usage cost, a material cost, a cost for maintenance and consumables, a cost for confirming qualification and aggregated value for these costs).

Hence, a user can compare a cost for every recipe and version.

In addition, the production management system 1 can indicate a cost not only for every process, but also for every piece of equipment.

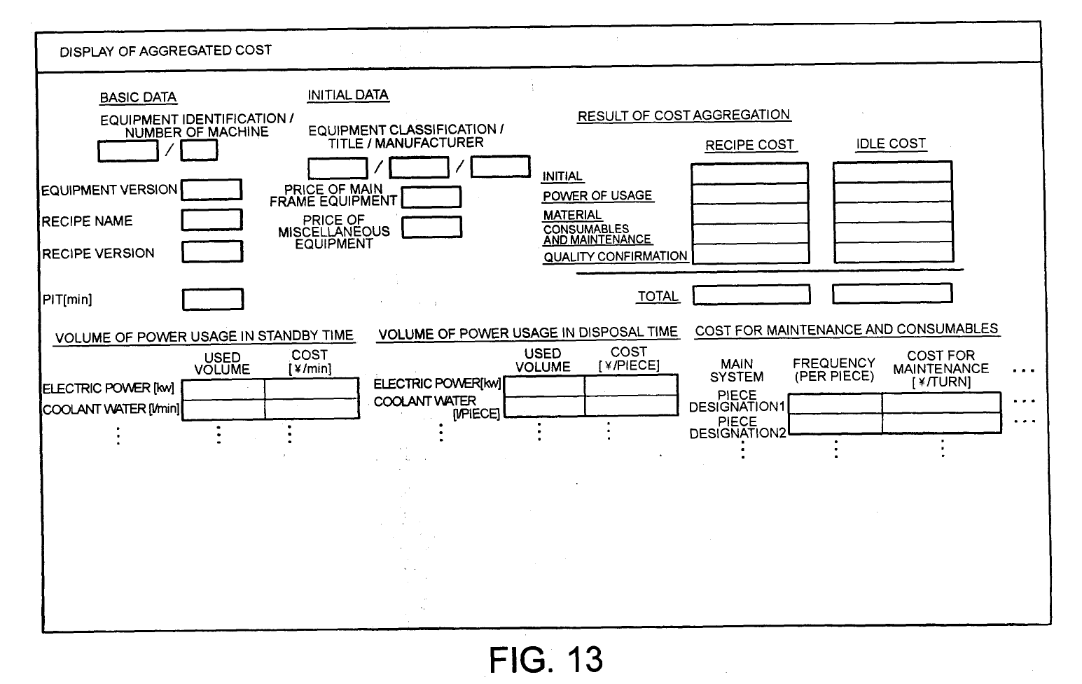

FIG. 13 is a schematic block diagram of an image showing the result of the cost aggregation for every piece of equipment relating to one example of the present embodiment.

As shown in FIG. 13, regarding a piece of equipment selected by a user, the image showing the result of cost aggregation for every piece of equipment displays basic data, initial data, the volume of power usage in standby time and in disposal time and a cost for them, a recipe cost, a cost for every item in the idle cost, a total cost, a cost for consumables and others.

Hence, for equipment selected by a user, he or she can confirm how much expenditure occurs regarding each item such as a recipe cost and an idle cost and others.

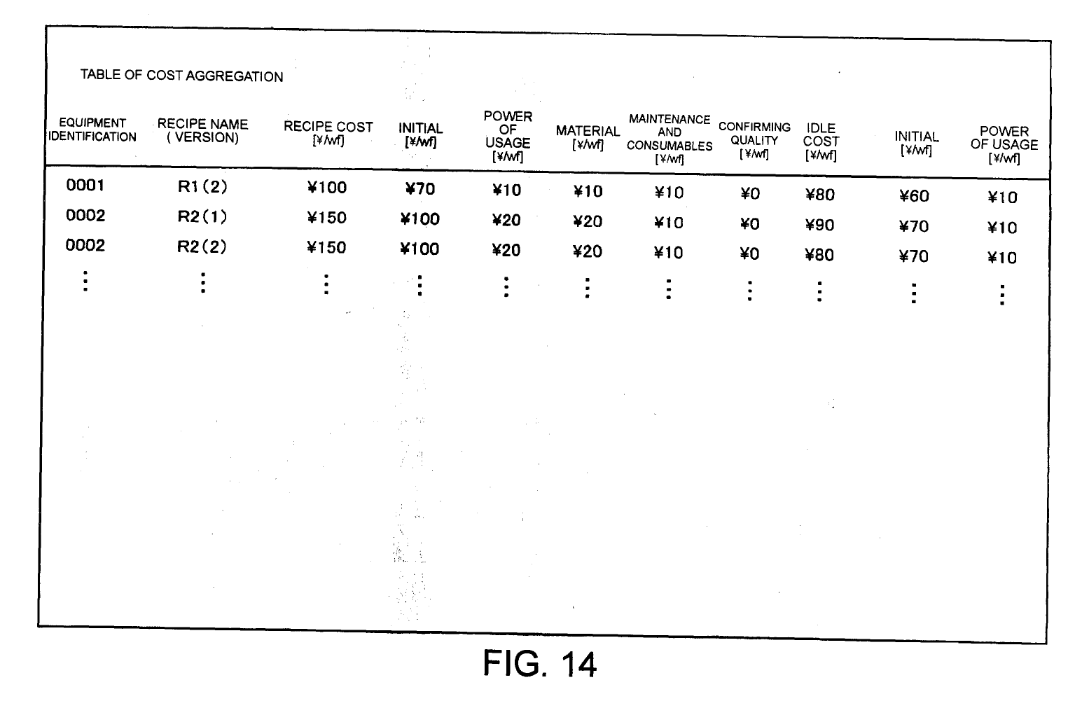

FIG. 14 is a schematic block diagram of an image showing the result of the cost aggregation for every piece of equipment relating to one example of the present embodiment.

As shown in FIG. 14, the image showing the result of cost aggregation for every piece of equipment displays equipment identification, production condition (recipe name and version), a recipe cost, a breakdown of a recipe cost (initial cost, a power usage cost, a material cost, a maintenance cost for consumables and a cost for confirming quality), an idle cost, a breakdown of the idle cost (an initial cost, a power usage cost, a material cost, a maintenance cost for consumables and a cost for confirming quality).

Hence, a user can confirm a recipe cost and an idle cost for every piece of equipment for each production condition by viewing an image indicating a list.

Therefore, according to the present embodiment, the idle cost indicating a cost per unit computing time is related to used equipment so as to establish the database for production equipment 44 and the database for miscellaneous equipment 45, the recipe cost indicating a cost per one piece of wafer is related to used equipment so as to establish the database for production disposal 43 and the production condition and the production process are related to used equipment so as to establish the database for production process information 42. Hence, the production management system 1 can more effectively and more precisely calculate a cost for every predetermined disposal unit such as for every equipment unit, production line unit, process unit, product unit, plant unit and others thereby.

In addition, according to a the present embodiment, data within the database for production process information 42, the database for production disposal 43, the database for production equipment 44 and the database for miscellaneous equipment 45 is related to a production type and version such that the management portion 10 can effectively implement computation for every product type and version in response to a user's request.

In particular, according to the present embodiment, the management portion 10 can effectively compute a cost for every process by establishing not only equipment unit, but data for every process unit in the database for production process information 42.

Hence, when the management portion 10 receives a request for changing the order of processes from a user, it can effectively compute a cost and others in case of substituting the order of processes to another in response to such request.

Furthermore, according to the present embodiment, aggregation can be implemented depending on the production size. A user can complete cost simulation in any size for example, such as a plant unit, a product unit, an equipment unit and others.

Therefore, when a user newly designs a plant, he or she uses the production management system 1 so as to effectively design a plant during a short period of time even if various versions and equipment are applied.

(Modification)

The preferred embodiments where the present invention is applied were described above. However, application of the present invention is not limited to the above mentioned embodiments.

For example, in the above mentioned embodiments, the output portion 30 expresses a cost for every version by table type. However, it may be expressed as a chart type for example.

In addition, in the above mentioned embodiments, the cost in process time was a recipe cost and the cost in standby time was a idle cost. However, in order to implement the above mentioned computing, only a portion of variation depending on process volume may be a recipe cost and a portion of no variation depending on process volume (a depreciation cost, for example) may be an idle cost.

In addition, the production management system 1 may rearrange various kinds of items as key factors and input and output data file in the above-mentioned image.

Furthermore, in the above-mentioned embodiments, the production management system 1 computes a cost. However, for example, energy needed for production disposal may be computed.

What is claimed is:

1. A production management system comprising;
means for inputting a request from a user;
means for computing a total cost in response to the request inputted by the means for inputting, based on a cost database in standby time relating used equipment to a cost per unit time in standby time, which shows a cost in standby time for every predetermined time unit varying in response to an elapsed time, a cost database in disposal time relating used equipment to a cost per unit disposal volume, which shows a cost in processing time every predetermined disposal unit varying in response to a production condition and a disposal volume, and a database for production process information relating used equipment to a production condition and a production process; and
means for indicating the total cost computed by the means for computing to the user by a predetermined format;
wherein the request includes a designation for production conditions showing a designation of the production conditions and a designation for aggregation unit showing the designation of aggregation unit in response to a size of the production process; and
wherein the means for computing:
selects at least one of used equipment in response to the designation for production condition,
computes a total cost in standby time in response to the designation of aggregation unit, based on an assumed standby time of the used equipment, and a cost in standby time per unit time of the used equipment,
computes a total cost in disposal time in response to the designation of aggregation unit, based on a designation of disposal volume included in the designation of the production condition, and a cost in disposal time per unit disposal volume of the used equipment selected in response to the designation for the production condition, and
computes the total cost based on the total cost in standby time and the total cost in disposal time.

2. The production management system according to claim 1, wherein:
at least one of the cost database in standby time, the cost database in disposal time and the database for production process information is related to a version, and the designation for production condition includes a designation for the version, and
the means for computing computes the total cost in response to the designation for the version, based on at least one of the cost database in standby time, the cost database in disposal time and the database for production process information.

3. The production management system according to claim 2, wherein
the designation for production condition includes a designation for a plurality of versions, the means for computing computes the total cost for every version and the means for indicating indicates the total cost to the user by the format showing the difference of the total cost for every version.

4. The production management system according to claim 1, wherein
the means for computing computes a cost per disposal unit or the total cost for every different production process, and the means for indicating indicates the cost per disposal unit or the total cost to the user for every different production process.

5. The production management system according to claim 1, wherein:
the used equipment includes equipment for manufacturing a semiconductor device, and
the aggregation unit is selected from the group consisting of a unit of semiconductor manufacturing plant, a unit of semiconductor manufacturing process, and a unit of semiconductor manufacturing line, and the means for computing computes a cost with regard to semiconductor manufacturing depending on the request, and the means for indicating indicates the cost with regard to semiconductor manufacturing to the user.

6. The production management system according to claim 1, wherein:
the means for inputting inputs at least one of cost varying in response to elapsed time of used equipment and a cost varying in response to a disposal volume of used equipment, and
the means for computing implements at least one of disposal of inputting a converted cost for every time unit to the cost database in the standby time, or disposal of inputting a converted cost for every disposal unit to the cost database in the disposal time, based on information with regard to a cost input by the means for inputting.

7. A program being readable by a computer and enabling a computer to function comprising:
an input means inputting request from a user;
a management means computing a total cost in response to the request inputted by the input means, based on a cost database in standby time relating a used equipment to a cost per unit time in standby time, which shows a cost in standby time every predetermined time unit varying in response to elapsed time, a cost database in disposal time relating a used equipment to a cost per unit disposal volume, which shows a cost in processing time every predetermined disposal unit varying in response to a production condition and a disposal volume, and a production process information database relating a used equipment to a production condition and a production process; and
an output means indicating the total cost computed by the management means to a user by a predetermined format, wherein;
the request includes designation for production condition showing a designation of the production condition and designation for aggregation unit showing a designation of aggregation unit in response to the size of production process, and
the management means
selects at least one of used equipments in response to the designation for production condition,
computes a total cost in standby time in response to the designation of aggregation unit, based on assumed standby time of the used equipment, and a cost in standby time per unit time of the used equipment;
computes a total cost in disposal time in response to the designation of aggregation unit, based on a designation of disposal volume included in the designation of the production condition, and a cost in disposal time per unit disposal volume of the used equipment selected in response to the designation for the production condition, and
computes the total cost based on the total cost in standby time and the total cost in disposal time.

8. An information storage medium storing a program being readable by a computer, and memorizing a program to make a computer function comprising:
an input means inputting request from a user;
a management means computing a total cost in response to the request inputted by the input means, based on a cost database in standby time relating a used equipment to a cost per unit time in standby time which shows a cost in standby time every predetermined time unit varying in response to elapsed time, a cost database in disposal time relating a used equipment to a cost per unit disposal volume, which shows a cost in processing time every predetermined disposal unit varying in response to a production condition and a disposal volume, and a production process information database relating a used equipment to a production condition and a production process; and
an output means indicating the total cost computed by the management means to a user by a predetermined format, wherein;
the request includes designation for production condition showing a designation of the production condition and designation for aggregation unit showing a designation of aggregation unit in response to the size of production process, and
the management means
selects at least one of used equipments in response to the designation for production condition,
computes a total cost in standby time in response to the designation of aggregation unit, based on assumed standby time of the used equipment, and a cost in standby time per unit time of the used equipment,
computes a total cost in disposal time in response to the designation of aggregation unit, based on a designation of disposal volume included in the designation of the production condition, and a cost in disposal time per unit disposal volume of the used equipment selected in response to the designation for the production condition, and
computes the total cost based on the total cost in standby time and the total cost in disposal time.

9. A method for production management comprising:
inputting a request including designation for condition, which indicates a designation for production condition, and a designation for aggregation unit, which indicates the designation of aggregation unit in response to a size of a production process from a user;
computing a cost in response to the designation for condition and the designation for aggregation unit inputted, based on a cost database in standby time relating used equipment to a cost at standby time per time unit, which shows a cost at standby time every predetermined time unit varying in response to an elapsed time, a cost database in disposal time relating used equipment to a cost per unit disposal volume in disposal time, which shows a cost in disposal time every predetermined disposal unit varying in response to process volume, and a database for production process information relating used equipment to a production condition, a production process and a production process order; and
indicating the computed cost to the user with a predetermined format.

10. The method of production management according to claim 9, further comprising:
relating at least one of the cost database in standby time, the cost database in disposal time and the database for production process information to a version;
including a designation of the version in the designation for production condition; and
computing the total cost in response to the designation of version, based on at least one of the cost database in standby time, the cost database in disposal time and the database for production process information.

11. The method of production management according to claim 10, further comprising:
including a designation of a plurality of versions in the designation for production condition; and
computing the total cost for every version and indicating the total cost to the user showing the difference of the total cost for every version.

12. The method of production management according to claim 9, further comprising:
computing the cost per disposal unit or the total cost for every different production process; and
indicating the cost per process unit or the total cost to the user for every different production process.

13. The method of production management according to claim 9, further comprising:
including equipment for manufacturing a semiconductor device in the used equipment;
selecting the aggregation unit from the group consisting of a unit of semiconductor manufacturing plant, a unit of semiconductor manufacturing process, and a unit of semiconductor manufacturing line;
computing a cost with regard to semiconductor manufacturing depending on the request; and
indicating the cost with regard to semiconductor manufacturing to the user.

14. The method of production management according to claim 9, further comprising:
inputting at least one of a cost varying in response to an elapsed time in standby time of used equipment and a cost varying in response to disposal volume of used equipment; and
implementing at least one of disposal of inputting a converted cost for every time unit to the cost database in the standby time, or disposal of inputting a converted cost for every disposal unit to the cost database in the disposal time, based on information with regard to an input cost.

15. A production management system comprising;
an input device that inputs a request from a user;
a processor that computes a total cost in response to the request inputted by the input device based on a cost database in standby time relating used equipment to a cost per unit time in standby time, which shows a cost in standby time for every predetermined time unit varying in response to an elapsed time, a cost database in disposal time relating used equipment to a cost per unit disposal volume, which shows a cost in processing time every predetermined disposal unit varying in response to a production condition and a disposal volume, and a database for production process information relating used equipment to a production condition and a production process; and
an output device that indicates the total cost computed by the processor to the user by a predetermined format;
wherein the request includes designation for production conditions showing a designation of the production conditions and a designation for aggregation unit showing the designation of aggregation unit in response to a size of the production process; and
wherein the processor:
selects at least one of used equipment in response to the designation for production condition,
computes a total cost in standby time in response to the designation of aggregation unit, based on an assumed standby time of the used equipment, and a cost in standby time per unit time of the used equipment,
computes a total cost in disposal time in response to the designation of aggregation unit, based on a designation of disposal volume included in the designation of the production condition, and a cost in disposal time per unit disposal volume of the used equipment selected in response to the designation for the production condition, and
computes the total cost based on the total cost in standby time and the total cost in disposal time.

16. The production management system according to claim 15, wherein:
at least one of the cost database in standby time, the cost database in disposal time and the database for production process information is related to a version, and the designation for production condition includes a designation for the version, and
the processor computes the total cost in response to the designation for the version, based on at least one of the cost database in standby time, the cost database in disposal time and the database for production process information.

17. The production management system according to claim 16, wherein the designation for production condition includes a designation for a plurality of versions, the processor computes the total cost for every version and the output device indicates the total cost to the user by the format showing the difference of the total cost for every version.

18. The production management system according to claim 15, wherein the processor computes a cost per disposal unit or the total cost for every different production process, and the output device indicates the cost per disposal unit or the total cost to the user for every different production process.

19. The production management system according to claim 15, wherein:
the used equipment includes equipment for manufacturing a semiconductor device, and
the aggregation unit is selected from the group consisting of a unit of semiconductor manufacturing plant, a unit of semiconductor manufacturing process, and a unit of semiconductor manufacturing line, and the processor computes a cost with regard to semiconductor manufacturing depending on the request, and output device indicates the cost with regard to semiconductor manufacturing to the user.

20. The production management system according to claim 15, wherein:
the input device inputs at least one of cost varying in response to elapsed time of used equipment and a cost varying in response to disposal volume of used equipment, and
the processor implements at least one of disposal of inputting a converted cost for every time unit to the cost database in the standby time, or disposal of inputting a converted cost for every disposal unit to the cost database in the disposal time, based on information with regard to a cost input by the input device.
